(19) United States
(12) Patent Application Publication
(10) Pub. No.: US 2005/0288994 A1
(43) Pub. Date: Dec. 29, 2005

(54) Method for auditing to determine compliance

(76) Inventor: Gregory D. Haunschild, Katy, TX (US)

Correspondence Address: D'AMBROSIO & ASSOCIATES, P.L.L.C., 10260 WESTHEIMER, SUITE 465, HOUSTON, TX, 77042, US

(21) Appl. No.: 10/874,587

(22) Filed: Jun. 23, 2004

(51) Int. Cl. G06Q 90/00

(52) U.S. Cl. 705/11

(57) ABSTRACT

A method and system for auditing compliance with rules and regulations emanating from government and other regulatory agencies comprising the steps of providing a secured, interactive web site system hosted by at least one computer server, accessibility to the web-based system limited to authorized users. Subject items specific for an authorized user are identified. The rules and regulations are analyzed for those potentially applicable to the identified subject item. Audit questions are formulated to determine if the one or more subject items are subject to and in compliance with applicable rules and regulations. Responses to the audit questions are analyzed to determine compliance. The responses are linked to a compliance software system to populate the compliance software with all the necessary subject item data for performing perpetual compliance reporting without the necessity of additional data entry.

### FIELD OF INVENTION

The present invention relates to a method for auditing to determine compliance. Particularly, the invention is directed to a web-based system of auditing to determine compliance with rules and regulations for industries subject to federal, state and local agencies, industry association standards and company policies.

### BACKGROUND

Most businesses and organizations today are subject to a myriad of ever-changing rules and regulations. This is especially true for those businesses that affect the environment or public safety. Many of the rules and regulations may be statutory when emanating from federal, state and local governments. Rules also emanate from industry organizations, such as the American Petroleum Institute (hereinafter, API), as well as a company's own policies and procedures. Companies are subject to inspections by government entities. These inspections can occur at any time. Frequently, a company performs its own audits or assessments to determine the state of its compliance with the mandated rules and regulations and determine if it will pass government inspection.

Cotter et al., U.S. Publication No. U.S. 2003/0069894, discloses a computer-based system for managing and controlling a firm's compliance with governmental regulations, particularly 21 CFR Part 11, comprising an electronic database that documents governmental regulations and associates the regulations with a firm's interpretations and best practices for compliance with such regulations. Cotter et al. also provides an electronic database for recording descriptive information relating to a computer-based system containing screening criteria to determine if the computer-based system being inventoried falls under the scope of the regulation. Another electronic database assesses if the computer-based systems in the inventory as well as those covered by the governmental regulation are in compliance with the regulation.

Sturgeon et al., U.S. Pat. No. 5,726,884 discloses an integrated hazardous substance tracking and compliance system for a regulated facility. The invention comprises eight functional groupings and a database coordinator that integrates the groupings and allows for data sharing among the groupings. Included in the groupings are functions such as permit management, material management, waste management, and emergency management. For example, the hazardous commitment management grouping contains compliance requirements and deadlines. The groupings may be used independently or in conjunction with each other to provide tracking and compliance, such as compliance with reporting requirements. In this way, an integrated approach for management of hazardous substances used or generated at a facility is achieved.

In U.S. Pat. No. 5,813,009, Johnson et al. discloses a computer based records management system for receiving, indexing and storing records. The records retained for permanent storage are verified and certified for compliance with preset criteria. These verified and certified records may only be altered or disposed by an authorized user. The invention also provides for record data unit tracking and an audit means for making a record of processing actions of the system. This provides for audit trails for any requirement of regulatory or legal compliance for discovery or other record unit requests.

A legal and regulatory compliance program is disclosed in Starnes et al., U.S. Publication No. U.S. 2002/01940014. A risk management system and computer program provide a source for risk management and compliance information. Starnes et al. allows businesses to identify potential liabilities, evaluate and implement risk management procedures. The invention further validates the recommended procedures for effectiveness. An associate module may be added to the system for record keeping and includes dates for particular laws and regulations, expiration dates and optional e-mail reminder notification.

Another system for compliance management is U.S. Publication No. U.S. 2002/0143595, Frank et al. Frank et al. discloses a compliance management system, which includes incident management and/or workflow management components. The system maintains records of work-related incidents, such as a chemical spill. The system interacts with other data management systems to produce a complete record of the incident. The workflow system tells a user who to notify in the event of an incident, the forms to be completed and what information to collect. A means for interfacing with third parties, such as governmental parties, governmental agencies, and officials is included.

The volume of government and industry regulatory requirements for a company's plants, equipment and personnel is continuously growing, constantly changing, and difficult to track. Audits are necessary to determine compliance with regulatory requirements. None of the above-referenced patents discuss or resolve the problem of having to continuously update rules and regulations. Nor do any address the copious data that is required to determine ongoing compliance with the myriad of rules and regulations.

### DEFINITIONS

Audit: formal examination to identify and ensure compliance with applicable compliance requirements.

Compliance requirements: rules and regulations emanating from one or more laws, statutory codes, federal, state and local government rules and regulations, permit requirements, required tasks, required actions associated with rules and regulations, standards, policies, procedures and guidelines of one or more regulatory authorities.

Evergreen: constantly current and up-to-date.

Facility Sites: land as well as structures and buildings located on the land.

Perpetual compliance: method of systematically and routinely verifying compliance with identified compliance requirements to maintain the compliance web site in a perpetual state of compliance.

Regulatory authorities: government legislatures, government agencies, industry associations, and company organizations.

Subject items: facility sites including land, structures and buildings on the land, assets at the facility sites, including equipment located at the facility sites, operational activities occurring at the sites and personnel that are subject to rules and regulations

### SUMMARY

This invention relates to an auditing method that enables a user to audit his/her company's compliance with rules and regulations promulgated by state and federal agencies, as well as industry associations and company organizations, at any point in time by providing online, real time compliance reporting. The audit is real time because the audit system of this invention is linked to a current database of rules and regulations. Beneficially, the method of this invention also links the responsive data elicited by the audit software to a compliance software system so that the company is able to track compliance with rules and regulations continuously, as well as do periodic spot check audits. The real time compliance feature of this invention is accomplished by having both the audit software and the compliance software linked to a site with current rules and regulations, current because they are updated periodically and routinely as changes occur. In this way, the audits and the compliance tracking are evergreen.

One preferred method for auditing to determine compliance with rules and regulations comprises the step of providing a secure, interactive web-based system accessible on the World Wide Web. Use of the web-based system is limited to those users who are authorized to access the system. The system links to a database, which includes the most current rules and regulations requiring compliance. Preferably, the rules and regulations are updated as changes occur. The system identifies one or more subject items subject to the rules and regulations. Subject items, that is, items subject to rules and regulations emanating from various government and industry entities, can include facility sites, assets such as equipment located at the facility sites, operational activities occurring at the sites and even personnel that are subject to government regulation, OSHA for example. The facility site preferably includes land as well as structures and buildings located on the land. During the method of this invention, the subject items specifically applicable to an authorized user are identified. The rules and regulations are analyzed for those potentially applicable to the identified subject item. Audit questions to an authorized user are then posed to determine if the one or more subject items are subject to and in compliance with the applicable rules and regulations. Next, the responses are analyzed to see if the subject items are in compliance. The responses are linked to a compliance software system to populate the compliance software with all the necessary subject item data for performing perpetual compliance reporting without the necessity of additional data entry.

Another preferred method for auditing to determine compliance with the rules and regulations from a regulatory authority, such as government legislatures, government agencies, industry associations, and company organizations comprises the step of providing a secure, interactive web-based system. Accessibility to the web-based system is limited to authorized users. The system is then linked to a database, which includes the rules and regulations requiring compliance. One or more subject items subject to the rules and regulations are identified. Subject items include facility sites, equipment located at the facility sites, and operational activities occurring at the sites that are subject to regulatory compliance. The next step is to determine applicable compliance requirements and potentially applicable compliance requirements for each of the one or more identified subject items. The rules and regulations determined to be potentially applicable are then downloaded and summarized. Included in the summarization of the regulation is a determination of the reasons for applicability of the compliance data requirements for the one or more identified subject items and reasons the potentially applicable compliance requirements are not currently applicable.

In this preferred method, an audit questionnaire is generated with questions designed to determine which regulations apply to the subject items or may apply if the subject items or rules are modified. The responses are then analyzed to asses if the subject items are in compliance. Subject items can comprise data organized at a facility site level, an equipment level, or a combination of both levels. An audit report is generated based on the analysis of the responses. The responses are linked to a compliance software system. Advantageously, the data resulting from the responses to the audit questionnaire is transmitted to the compliance software system to allow for perpetual compliance tracking. The compliance software system is now populated with all of the data emanating from the audit. The time consuming process of reentering data regarding the items subject to compliance as well as their compliance status is no longer necessary under the method and system of this invention.

Yet another preferred method for auditing to determine compliance with rules and regulations also comprises a secure, interactive web-based system. Accessibility to the web-based system is limited to authorized users. The system links to an environmental database which includes the rules and regulations requiring compliance and identifies one or more subject items subject to the rules and regulations. The environmental database is analyzed to determine specific regulations that are potentially applicable to the identified subject items. The regulations are then summarized and an audit questionnaire is generated to determine if each one of the subject items is subject to the potentially applicable regulations. An audit report depicting an organization's compliance with environmental rules and regulations at that particular moment in time is generated based on the analysis of the responses. The responses are then linked to a compliance software system. The data resulting from performing the audit then populates the compliance software system. The data resulting from the audit is transmitted to the compliance software system for perpetual compliance tracking without additional input of data necessary for tracking.

Without the continuous updating of rules and regulations of the present invention, each audit would quickly become obsolete once completed. That is, the audit manual produced is static and becomes obsolete as soon as regulation requirements are amended or changed or assets are modified. The audit method of this invention is dynamic because the linkage feature of this invention links the audit software to a site with constantly updated rules and regulations. Once the audit software system is populated with a company's sites and equipment that are subject to regulatory compliance, an up-to-date audit can be performed at any time.

### BRIEF DESCRIPTION OF DRAWINGS

FIG. 1 is a flowchart of one embodiment of the method of this invention.

FIG. 2 is a sample web page illustrating site data required for auditing.

FIG. 3 is a sample web page illustrating equipment data required for auditing.

FIG. 4 is a schematic of one embodiment of the method of this invention.

### DETAILED DESCRIPTION OF THE PREFERRED EMBODIMENTS

This invention relates to a method of auditing to assess a company's compliance, at any single moment in time, with a multitude of rules and regulations. Most organizations, particularly industrial companies, must comply with a multitude of rules and regulations emanating from state and federal agencies, industry standards, watchdog organizations and the organization's own polices and procedures. Many of these organizations are subject to government inspections to determine compliance with the rules and regulations. An audit is a “snap shot” of an organization or company's state of compliance with rules and regulations at any give time. Companies often conduct their own internal audits or assessments to determine if their employees are carrying out the tasks necessary for compliance. The method of this invention comprises using an audit system that is linked to a web site having the most current rules and regulations so that the rules and regulations remain evergreen and as a result of an audit, the company is aware of, and can become in compliance with, new and updated regulations as they occur. In this way, the audit method of this invention is driven by the regulations. Once an audit is performed according to the method of this invention, all of the identified requirements (data) necessary for compliance is transmitted to a compliance system. The compliance system is also linked to a site so that it is updated periodically to reflect current rules and regulations. Activities performed by the company to fulfill compliance requirements are also entered into the compliance system. Using this updated data from the previous audit, the company, or agents of the company can perform an audit at any time, without reentering copious data.

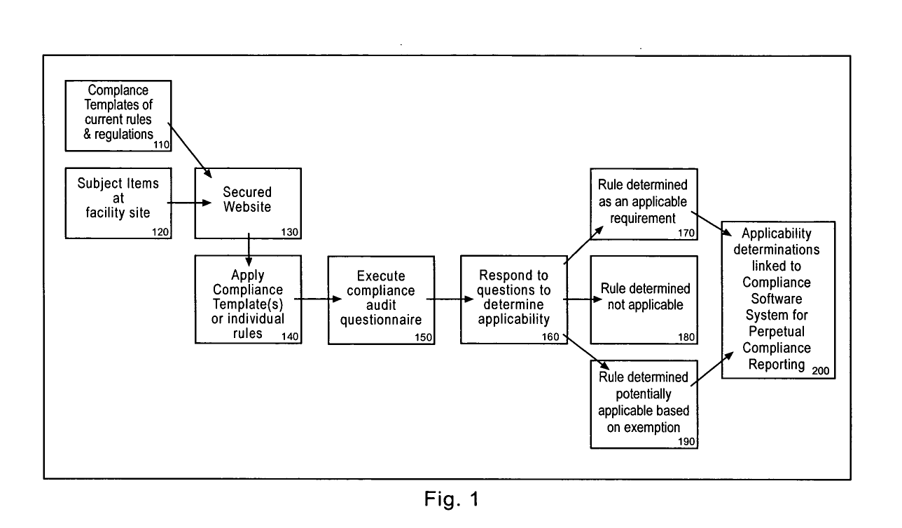

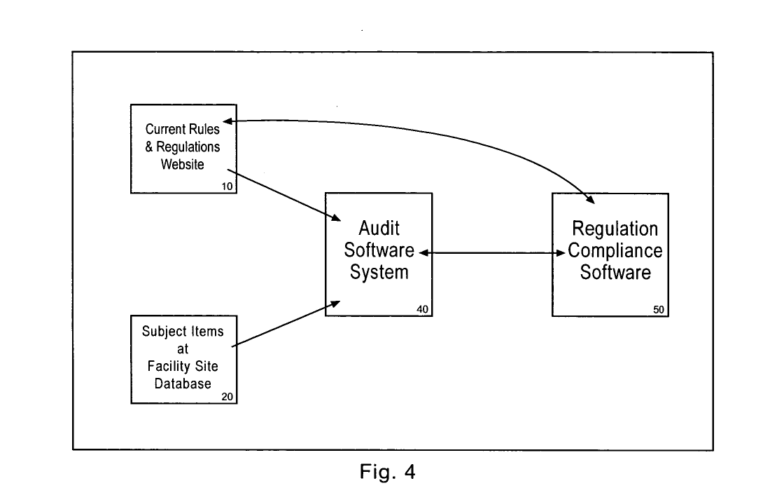

FIG. 4 is a schematic illustrating the databases and software systems used during the practice of this invention. FIG. 1 is a flow chart of the steps of this method. Referring to FIG. 4, the current compliance rules and regulations used in the present audit method emanate from a frequently and routinely updated web site 10 to reflect the changes and amendments to the rules so the rules and regulations are evergreen. This web site 10 is linked to the audit software system 40. In another aspect of the method of this invention, the audit system 40 further comprises one or more interactive functions, the interactive functions can comprise a query, sort and find function for determining regulatory compliance rules and regulations applicable to identified subject items, and a reporting function to generate audit and or compliance reports.

The information and data regarding the audit items subject to compliance must be entered into a database 20 accessible to the audit software system 40. The volume of data for an audit includes identification data for the subject items. Subject items included in the database 20 are facility sites, comprising site locale, buildings and structures located on the site locale. Subject items can also comprise personnel at the site, equipment, and operational activities subject to compliance, such as preventative maintenance activities that are not time defined, specific to a facility. This data grows continuously and is often difficult to track, especially since the rules and regulations emanate from a variety of sources and an organization's resources affected by the rules and regulations, i.e., equipment, facility sites, personnel, etc, change periodically. It has been difficult and time consuming for an organization to remain in compliance after an initial audit because prior audits were based on a static set of rules and regulations. Compliance after the initial audit required revisiting each rule and regulation to determine if amended, and if amended, an analysis to check that the subject item was still in compliance.

During the audit method of this invention, current rules and regulations downloaded from an evergreen web site 10 and the data for subject items at a facility targeted for audit 20 populate the audit software system 40. Once the audit is completed, the resulting data is sent to a regulatory compliance software system 50 so that compliance can be tracked perpetually since the compliance software is also linked to the web site having the current rules and regulations 10 as shown in FIG. 4. With the linking of the audit system to the compliance system, audit data populates the compliance system. The status of compliance of the subject items identified in the audit system can then be kept current, as well as updating the identified requirements as described below. In this way, the compliance status of any number of the company's subject items can be audited at any time without copious reentering of data.

Compliance software is available that not only tracks requirements for compliance and whether or not the requirements have been met but also is linked to a web site having consistently updated rules and regulations. One such software is the AEMS Online Regulatory Compliance System and Method for Facilitating Compliance, Publication No. U.S. 2003 0217036 A1, incorporated herein as if produced in its entirety. This compliance software tracks compliance and continues to notify responsible parties until subject terms are in compliance.

The audit method of this invention is a dynamic process because it links the data generated during the audit to a compliance software system so that the compliance software can be populated with current subject matter data as well as current rules and regulations. In this way, the organization can track compliance based on the most current regulatory information elicited during the audit as well as continuously perform spot check audits ensuring that identified subject items are always in compliance. The analyzed responses linked to the compliance software system for perpetual compliance tracking generate a perpetual audit system and, therefore, a perpetual compliance system. An audit reflects a spot check, at any particular moment in time, of an organization's compliance with specific rules and regulations.

Referring to the FIG. 1, the method for auditing to determine compliance with applicable rules and regulations provides a secured, interactive web-based system 130 that facilitates auditing a company's compliance with a multitude of rules and regulations. Accessibility to the web site 130 is limited to authorized users. Identification means such as passwords are required to access the web site. Authorized users can include an organization's personnel, vendors and service providers or even a government regulatory agent who is given access to facilitate government inspections of the organization's facility. In one aspect, the web-based system is accessible on the World Wide Web. An alternative embodiment of the method of auditing comprises providing a software system for auditing on a secured interactive web site that is accessible to multiple computers via network connectivity, a LAN (Local Area Network) system or WAN (Wide Area Network) system, for example.

The web-based system is linked to a database comprising rules and regulations that require compliance by the organization. The rules and regulations emanate from one or more laws, statutory codes, government rules, regulations, permit requirements, required tasks, required actions associated with rules and regulations, standards, policies, procedures, and guidelines of one or more regulatory authorities. Regulatory authorities can comprise government legislatures, government agencies, industry associations, and company organizations. In one aspect, the rules and regulations are downloaded as templates. Importantly, these rules and regulations are current. Government regulations are frequently amended and new regulations written. Organizations must keep abreast with these changes. The database linked to the auditing system used during the method of this invention is updated frequently so that the rules and regulations are evergreen. The evergreen rules and regulations can be downloaded as compliance templates at the beginning of the audit 110.

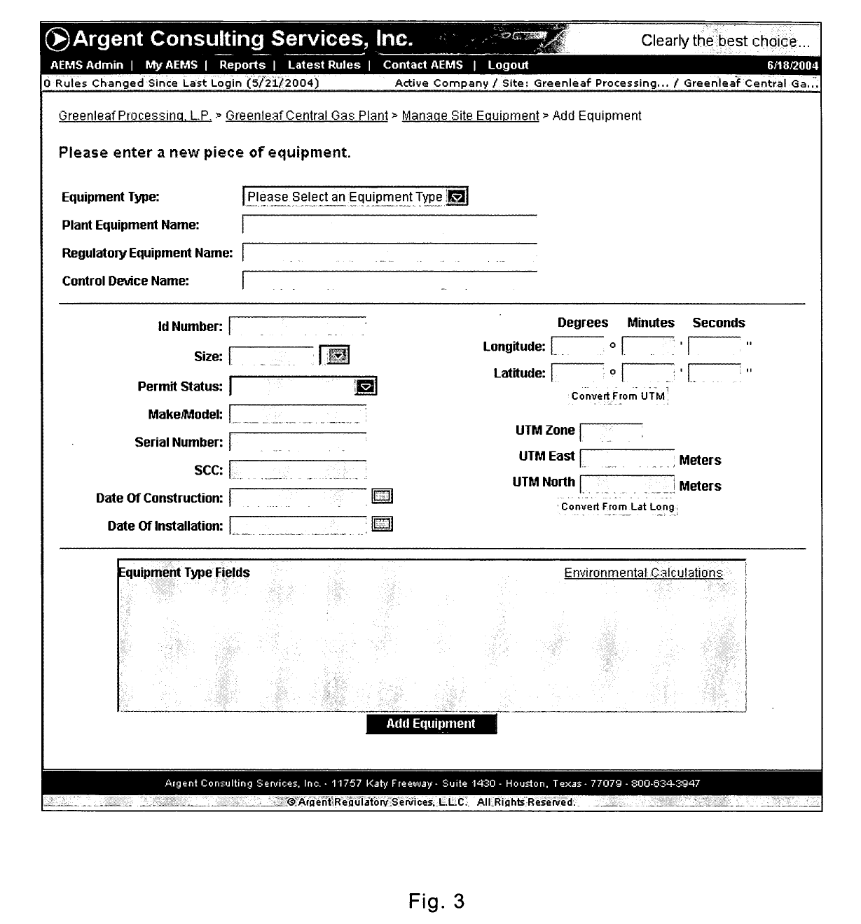

Once an authorized user is logged onto the web site, and the audit is being performed for a new facility site, the user must identify and enter in data for subject items at that facility site that may be subject to compliance rules and regulations. The data comprises information regarding the items that are subject to the rules and regulations presently located at the site 120. The subject items include the facility site itself, equipment located on site, personnel subject to regulations such as OSHA, materials, activities that may be regulated, such as inspecting pipelines periodically, and permits that must be filed prior to performing certain activities or using certain equipment. The information that must be entered can be time consuming. For example, FIG. 3 illustrates the data required for a specific engine. The data entered includes the name, ID number, make, model, serial number, date of construction, permit status and emissions limits. In one advantageous aspect of this invention, a pre-prepared database can be included in the audit system that lists all subject items, with its relevant data, that possibly could be used at a specific facility site. In this way, the user can select those subject items applicable to the facility site under audit without reentering data. Alternatively, if the organization has performed prior audits with this system or compliance management with the compliance software system linked to the audit system, the audit software system can populate the subject matter database 20 by transmitting its data to the compliance software system.

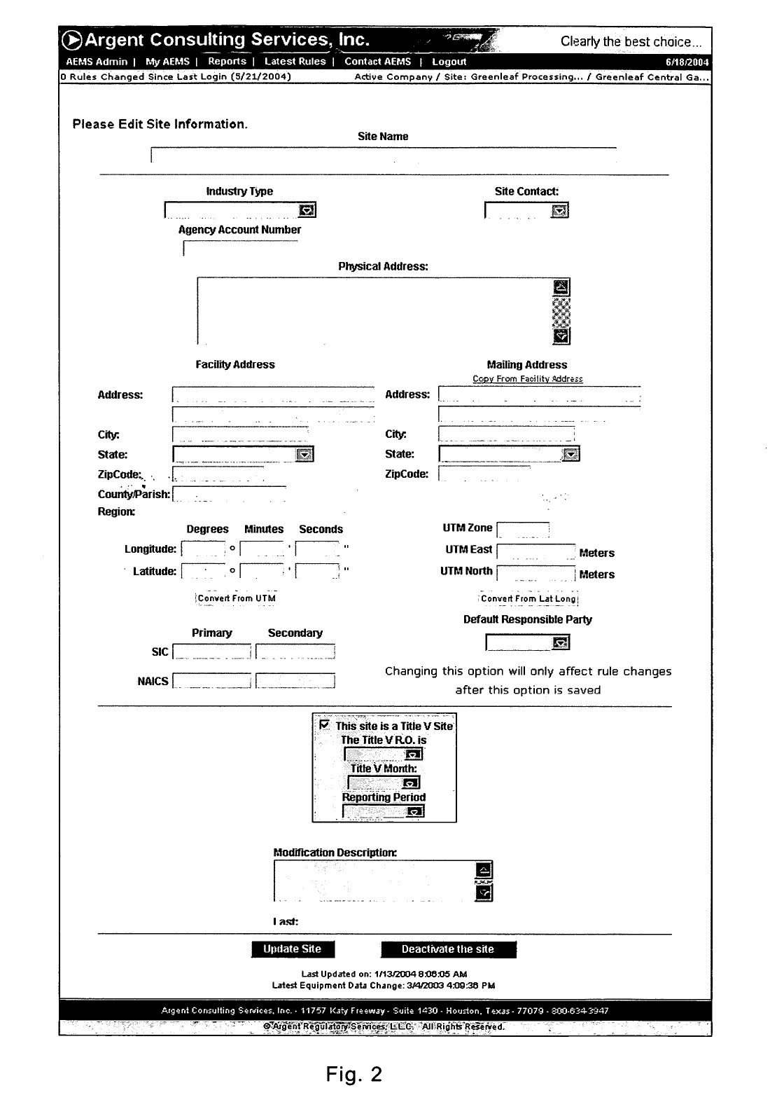

In still another alternative method of auditing, the provider of the audit method works with the organization to develop a profile of the organization and it's audit needs. The audit web site is customized according to the profile so that the facility site subject items are entered prior to the audit. FIG. 2 is a web screen illustrating the information available once a site is selected. The figures are for illustrative purposes only and not limited to any particular industry or organization. The company profile delineates site location, agency descriptions and personnel who are responsible for compliance for that site. The subject items specific for that site locale are identified and selected by the user. FIG. 2 illustrates typical site information and FIG. 3 lists one type of equipment information, compressor engines in this embodiment. The data included for the equipment can vary depending on the organization's needs.

Preferably, the audit method includes the step of formatting the regulatory compliance rules and regulations as a summary. During one preferred method, templates are created that have a summary of each rule or regulation that is potentially applicable. Hyperlinks to the full regulation can be added to the summary web page. The step of summarizing the regulations can further comprise selecting required data from a group of required data comprising tasks for compliance, routine operational procedures necessary for compliance, exemptions from requirements, timing information and compliance triggers necessary to fulfill regulatory compliance requirements for one or more identified subject items. Another aspect of the step of summarizing further includes distinguishing presently applicable compliance requirements for subject items from potentially applicable compliance requirements for subject items. Potentially applicable compliance requirements are those that may apply to the specific site or equipment but do not presently apply due to exemptions that can be claimed. For example, a tank may have a volume that is below the applicability threshold or a manufacturing facility may have a capacity that is less than the applicability threshold. In one aspect, the summary of the regulation preferably includes the further step of reporting the reasons for applicability of compliance data requirements and reasons potentially applicable requirements are not currently applicable. If the rules change, or if equipment is updated, a potentially applicable rule or regulation may become applicable.

Referring back to FIG. 1, once the audit system used during the method of this invention is populated with current rules and regulations as well as data regarding identified items subject to audit, the rules and regulations are analyzed to determine which rules and regulations are potentially applicable for the identified subject items. A summary of rules and regulations can be prepared in advance, preferably as templates. The applicable templates are selected and an audit questionnaire is designed to determine if one or more subject items are subject to and in compliance with the presently applicable and potentially applicable rules and regulations. Audit questions are created and posed to the user. The responses to audit questions are analyzed to determine if the subject items are in compliance. The results of audit analysis can be reported in a variety of ways known in the art.

In one method of the invention, the results are reported in an audit report or manual, either electronically or in hard copy. Alternatively, the results, in the form of the audit report, are transmitted to the compliance software system 50, 200. Preferably, the responses are linked to a compliance software system 50 for performing perpetual compliance reporting. The data resulting from the responses to the audit questions is transmitted to the compliance software system. Ongoing and perpetual compliance tracking and reporting can be accomplished once the compliance software system is populated with the data from the audit. Future spot check audits are performed based on the analysis of the responses to the audit questions. If the responses to the questionnaire are transmitted to the compliance software system, the compliance software system can produce a dynamic compliance or audit system that perpetually tracks compliance of its subject items. During the method of this invention, the rules and regulations are continuously updated by the link to the current regulatory site 50 so that the user need only update the data regarding the subject items (new equipment or changes to existing equipment, for example.) to determine the state of compliance for its facility site. In one aspect of this invention, the data resulting from the analyzed responses transmitted to the compliance software system is organized at a facility site level, an equipment level, or a combination of both levels.

In an alternative method for auditing to determine compliance, the compliance regulations are environmental regulations. During this method, a secured, interactive web-based system is provided that is accessible on a web-based system and limited to authorized users. The system is linked to a database comprising current environmental regulations requiring compliance. The environmental regulations are downloaded to the audit system. The environmental regulations are continuously updated so as to remain evergreen. One or more subject items subject to the regulations are identified and the environmental regulations analyzed to determine specific regulations potentially applicable for the identified subject items. Preferably the method comprises a step of summarizing the regulations so that the user sees the most pertinent information in an easy to comprehend format. The step of summarizing the regulations can include selecting required data from a group of required data comprising tasks for compliance, routine operational procedures necessary for compliance, exemptions from requirements, timing information and compliance triggers necessary to fulfill regulatory compliance requirements for one or more identified subject items. Summarizing the regulations can also include determining the reasons for applicability of the compliance data requirements for one or more identified subject items and reasons the potentially applicable compliance requirements are not currently applicable.

An audit questionnaire is generated to determine if the one or more subject items are subject to the applicable and potentially applicable regulations. The responses to the audit questionnaire are analyzed to determine if the one or more subject items are in compliance and an audit report generated based on the analysis of the responses. The responses are linked to a compliance software system. The data resulting from the responses to the audit questions is then transmitted to the compliance software system for perpetual auditing and thus perpetual compliance assurance. Compliance reports and audit manuals can be produced by authorized users of the auditing and compliance system.

The foregoing description is illustrative and explanatory of preferred embodiments of the invention, and variations in the method, systems and other details will become apparent to those skilled in the art. It is intended that all such variations and modifications which fall within the scope or spirit of the appended claims be embraced thereby.

1. A method for auditing to determine the applicability of and compliance with compliance rules and regulations:
(a) providing a secured, interactive web-based system, accessibility to the web-based system limited to authorized users;
(b) linking to a database with periodically and routinely updated rules and selected regulations requiring compliance, downloading one or more rules and regulations;
(c) identifying one or more subject items subject to the rules and regulations;
(d) posing audit questions to determine if the one or more identified subject items are subject to and in compliance with the applicable and potentially applicable rules and regulations;
(e) analyzing responses to audit questions to determine if the one or more subject items are in compliance;
(f) linking the responses to a compliance software system for performing continuous auditing and compliance.

2. The method of claim 1 wherein the web-based system is accessible on the World Wide Web.

3. The method of claim 1 wherein the rules and regulations emanate from one or more laws, statutory codes, government rules, regulations, permit requirements, required tasks, required actions associated with rules and regulations, standards, policies, procedures, and guidelines of one or more regulatory authorities.

4. The method of claim 3 wherein the one or more regulatory authorities comprise government legislatures, government agencies, industry associations, and company organizations.

5. The method of claim 1 further comprising the step of summarizing the rules and regulations.

6. The method of claim 5 further comprising the step of determining which rules and regulations are presently applicable compliance requirements and which rules and regulations are potentially applicable to the one or more subject items.

7. The method of claim 5 wherein the step of summarizing the regulations further includes selecting required data from a group of required data comprising tasks for compliance, routine operational procedures necessary for compliance, exemptions from requirements, timing information and compliance triggers necessary to fulfill regulatory compliance requirements for one or more identified subject items.

8. The method of claim 5 wherein the step of summarizing the regulations further includes determining the reasons for applicability of the compliance data requirements for one or more identified subject items and reasons the potentially applicable compliance requirements are not currently applicable.

9. The method of claim 1 wherein the one or more subject items comprise facility sites, equipment located at the facility sites and operational activities occurring on the sites, the facility sites, equipment and operational activities being subject to regulatory compliance.

10. The method of claim 1 further comprising the step of designing a questionnaire to determine if the one or more subject items are in compliance with regulations.

11. The method of claim 1 further comprising the step of continuously updating the regulations.

12. The method of claim 1 wherein the step of linking the responses to the compliance software system further comprises the step of transmitting the data resulting from the responses to the audit questions for perpetual auditing and perpetual compliance assurance.

13. The method of claim 1 wherein the step of linking the responses to the compliance manual software system further comprises performing perpetual audits based on the analysis of the responses to the audit questions.

14. The method of claim 1 further comprising the step of producing an audit system.

15. A method for auditing to determine compliance with compliance rules and regulations:
(a) providing a secured, interactive web-based system, accessibility to the web-based system limited to authorized users;
(b) linking to a database with regulations requiring compliance;
(c) downloading the rules and regulations;
(d) summarizing the rules and regulations;
(e) identifying one or more subject items subject to the rules and regulations and selecting the summaries potentially applicable to the identified subject items;
(f) generating an audit questionnaire to determine if the one or more subject items are subject to presently applicable regulations as well as potentially applicable regulations;
(g) analyzing responses to the audit questionnaire to determine if the one or more subject items are in compliance;
(h) generating an audit report based on the analysis of the responses;
(i) linking the responses to a compliance software system; and
(j) transmitting the data resulting from the responses to the audit questionnaire to the compliance software system for perpetual compliance tracking.

16. The method of claim 15 wherein the regulations emanate from one or more laws, statutory codes, government rules, regulations, permit requirements, required tasks, required actions associated with rules and regulations, standards, policies, procedures and guidelines of one or more regulatory authorities.

17. The method of claim 16 wherein the one or more regulatory authorities comprise government legislatures, government agencies, industry associations, and company organizations.

18. The method of claim 15 further comprising the step of determining the applicable compliance requirements and potentially applicable compliance requirements for each of the one or more subject items.

19. The method of claim 15 wherein the step of summarizing the regulations further includes determining the reasons for applicability of the compliance data requirements for the one or more identified subject items and reasons the potentially applicable compliance requirements are not currently applicable.

20. The method of claim 15 wherein the audit report is transmitted to the compliance software system.

21. The method of claim 15 wherein the step of transmitting data resulting from the analyzed responses of step ( ) to the compliance software system comprises organizing the data at a facility site level, an equipment level, or a combination of both levels.

22. The method of claim 15 wherein the step of linking the responses to a compliance software system for perpetual compliance tracking further comprises the step of producing a perpetual audit system.

23. The method of claim 15 wherein the step of linking the responses to a compliance software system for perpetual compliance tracking further comprises the step of producing a compliance assurance system.

24. A method for auditing to determine compliance with environmental rules and regulations:
(a) providing a secured, interactive web-based system, accessibility to the web-based system limited to authorized users;
(b) linking to a database with current environmental rules and regulations requiring compliance; downloading the regulations;
(c) identifying one or more subject items subject to the rules and regulations;
(d) analyzing the regulations to determine specific rules and regulations potentially applicable for the one or more identified subject items
(e) summarizing the rules and regulations;
(f) generating an audit questionnaire to determine if the one or more subject items are subject to the presently applicable as well as potentially applicable regulations;
(g) analyzing responses to the audit questionnaire to determine if the one or more subject items are in compliance;
(h) generating an audit report based on the analysis of the responses;
(i) linking the responses to a compliance software system; and
(j) transmitting the data resulting from the responses to the audit questions to the compliance software system for perpetual compliance tracking.

25. The method of claim 24 wherein the environmental rules and regulations emanate from one or more laws, statutory codes, government rules, regulations, permit requirements, required tasks, required actions associated with rules and regulations, standards, policies, procedures and guidelines of one or more regulatory authorities.

26. The method of claim 24 wherein the one or more regulatory authorities comprise government legislatures, government agencies, industry associations, and company organizations.

27. The method of claim 24 wherein the step of summarizing the rules and regulations further includes selecting required data from a group of required data comprising tasks for compliance, routine operational procedures necessary for compliance, exemptions from requirements, timing information and compliance triggers necessary to fulfill regulatory compliance requirements for one or more identified subject items.

28. The method of claim 24 wherein the step of summarizing the rules and regulations further includes determining the reasons for applicability of the compliance data requirements for one or more identified subject items and reasons the potentially applicable compliance requirements are not currently applicable.

29. The method of claim 24 wherein the one or more subject items comprise facility sites, equipment located at the facility sites and operational activities occurring on the sites, the facility sites, equipment and operational activities being subject to regulatory compliance.

30. The method of claim 24 further comprising the step of continuously updating the government rules and regulations.

31. The method of claim 24 wherein the step of linking the responses to the compliance software system further comprises the step of performing perpetual auditing based on the analysis of the responses to the audit questionnaire.

32. The method of claim 24 wherein the step of linking the responses to the compliance manual software system further comprises performing perpetual compliance reporting.
